(19) United States
(12) Patent Application Publication
(10) Pub. No.: US 2026/0336787 A1
(43) Pub. Date: Oct. 29, 2026

(54) PIVOTING WING AS PARTIAL-PROFILE PIVOTING WING WITH PIVOTABLE PARTIAL-PROFILES

(71) Applicant: INNOMATION GMBH, Matzendorf (AT)

(72) Inventor: Franz KARGL, Waidhofen an der Thaya (AT)

(73) Assignee: INNOMATION GMBH, Matzendorf (AT)

(21) Appl. No.: 19/101,509

(22) PCT Filed: Aug. 2, 2023
(86) PCT No.: PCT/EP2023/071404

§ 371 Date: Feb. 5, 2025

(30) Foreign Application Priority Data
Aug. 17, 2022 (AT) A 60124/2022

(51) Int. Cl. B64C 3/40

(52) U.S. Cl. CPC B64C 3/40

(57) ABSTRACT

The invention relates to a pivoting wing (1) for an aircraft (11), characterised in that the pivoting wing (1) is designed as a partial-profile pivoting wing wherein the partial-profile pivoting wing is assembled from individual partial profiles when these partial profiles are pivoted together.

### TECHNICAL FIELD

The invention relates to a pivoting wing as a partial-profile pivoting wing with pivotable partial profiles.

### BACKGROUND

With aircraft such as VTOLs (VTOLs stands for aircraft with vertical take-off and landing capabilities, i.e. can take off and land vertically), which can be manned or unmanned, or UASs (UASs stands for unmanned aerial systems, i.e. unmanned aircraft), etc., attempts are being made to create a mixture of conventional aircraft and helicopters in order to realize various flight states. VTOLs usually have a number of propellers or other drives that can lift the aircraft like a helicopter or similar to a multicopter. The forward flight is generated similarly to a helicopter or multicopter or by an additional drive that moves the aircraft forward. Usually no aerofoil is used here.

In the course of aviation development, various concepts for aircraft with pivoting wings were proposed.

For example, DE 37 10914 A1 discloses an aircraft of variable geometry with devices for adaptation to different flight states, wherein the wings (left and right complete wings) can be pivoted about vertical axes of rotation (vertical axis) in order to adapt the sweep to the flight speed.

Another example of an aircraft with pivoting wings and different flight states is known, for example, from DE 20 2016 005 012 U1. Disclosed there is a vertical take-off and landing aircraft with electric fans (ventilators) in the wings, which comprises foldable pivoting wings whose variable sweep is used to trim the centres of uplift of the wings and fans or in the event of their failure.

However, all of these known pivoting-wing-based aircraft are associated with the problem that they do not have a broad spectrum of flight states that are really easy to implement and -with regard to the overall centre of gravity-stable to operate.

Against this background, the object of the invention is to provide an improved pivoting wing, with the aid of which a significantly more flexible and stable flight behaviour under a wide variety of flight states of an aircraft equipped therewith is possible.

### SUMMARY OF THE INVENTION

This object is achieved by a pivoting wing according to claim 1. The subject matter of the invention is therefore a pivoting wing for an aircraft, wherein the pivoting wing is designed as a partial-profile pivoting wing, wherein the partial-profile pivoting wing is assembled from individual partial profiles when these partial profiles are pivoted together.

This object is further achieved by an aircraft according to claim 13. The subject matter of the invention is therefore an aircraft comprising a fuselage configuration which, depending on the design, comprises a fuselage or a double fuselage or a multiple fuselage construction, and a pivoting wing according to the invention on the left and right sides of the fuselage configuration. Furthermore, partial-profile pivoting wings can also be attached to the ends of stub wings.

Along the fuselage configuration, such as along the single fuselage, i.e. the longitudinal extension of the fuselage from the nose to the tail, the directions left and right are defined in the conventional way. From the cockpit, the pilot looks forwards (nose) in the direction of flight and the wings extend to his left and right sides, i.e. port and starboard.

This object is further achieved by a computer-aided method according to claim 16. The subject matter of the invention is therefore a computer-aided method for operating an aircraft in the flight states listed hereinafter, namely:

in a horizontal flight state in which the partial profiles of the respective partial-profile pivoting wing are pivoted together and a complete wing formed in this way generates the aircraft uplift with the effect of a drive, in particular the respective partial profile, like a conventional aircraft, and

in a transition flight state in which the partial profiles are moved apart so that partial wings are formed from the complete wing, whereby the aircraft uplift of the complete wing decreases, possibly being partly taken over by the individual partial wings, whilst the drive or a direction of action of the drive is successively pivoted in such a way that the decrease in the uplift of the complete wing is compensated when the partial profiles move apart, and

in a take-off or landing or hovering flight state in which the partial profiles of the partial-profile pivoting wing are moved apart and purely the directional effect of the drive generates the power needed for the take-off and landing or hovering flight state.

The measures according to the invention are accompanied by the effect that the partial-profile pivoting wing that can be pivoted out or separated into partial profiles, i.e. the divisible pivoting wing, provides the basis for an aircraft equipped therewith to develop maximum flexibility with regard to its possible flight states. With the aid of the pivoted-out pivoting wing, the drives on both sides of the aircraft can be optimally distributed around the centre of gravity of the aircraft, so that the drives can be positioned with a maximum lever arm to the centre of gravity of the aircraft, whereby very stable flight and control behaviour is guaranteed.

Furthermore, the invention is not only applicable to conventional wings, but can also be used in other applications that are profile-based, such as propellers, (engine) fans, turbine blades or rotor blades. Since the partial profiles are not completely spread apart, i.e. when there is no or only a small gap between the partial profiles, the wing surface is enlarged with the resulting advantages when this is required.

The aircraft can thus be flown in the so-called horizontal flight mode or horizontal flight state like a conventional aircraft when the partial profiles are joined together. The joined-together partial profiles on the left and right sides of the fuselage each form a complete wing of the aircraft with a complete wing profile typical for aircraft, which complete wing profile has air flowing around it due to the effect of the drive, thereby creating the aircraft uplift. In this configuration, the aircraft has the flight behaviour of a conventional aircraft. Even without the effect of the drive it can glide or soar. In addition, all aircraft-typical control surfaces or uplift aids can be installed on the front, top, bottom and back of the complete profile (e.g. de-ice, anti-ice, slats, flaps, rudder and the like).

Furthermore, when the partial profiles are moved apart or pivoted out, i.e., when the partial profiles of the respective partial-profile pivoting wing are arranged separately from one another and thus no longer form the complete wing, but form individual partial wings, the aircraft can either be flown in the so-called transition flight state or in the take-off or landing or hovering flight state.

In the take-off or landing or hovering flight state, the effect of the drive provided on a partial wing is directed downwards, so that the downward force required for this flight state is provided directly or exclusively by the drive. The respective partial wings in this case only have a supporting or holding effect for the respective drive. In this configuration, the aircraft has flight characteristics similar to a helicopter or a multicopter. The configuration of the partial wings with their drives corresponds to that of a quadrocopter or, more generally, similar to a multicopter, which brings about an extremely stable flight behaviour even at the lowest climb or descent speeds, or horizontal speed or even when standing still horizontally or hovering.

The transient flight state or in other words the transition flight state exists in two situations.

In the first situation, a change from the horizontal flight state to the take-off or landing or hovering flight state is made as soon as the partial profiles are pivoted apart and the reduced uplift of the complete wing is successively compensated by an effect of the drives gradually aligning downwards (towards the earth).

In other words, the effect of the drive when the partial profiles are moved apart by pivoting the drive as such, i.e. its effect (thrust), is converted from propulsion into a downward force, in the present case also designated as lifting force or lift so that the propulsion originally generated by the drive, which causes the aircraft uplift via the complete wing, successively decreases and at the same time the lifting force successively increases and thus the decrease in the uplift of the complete wing is taken over in order to keep the aircraft in the air or to allow it to take off or land vertically.

In the second situation, a change from the take-off or landing or hovering flight state to the horizontal flight state is made, i.e. the partial profiles are pivoted towards each other and the effect of the drive, which is initially only directed downwards (towards the earth), is successively directed backwards, whilst the complete wing is formed and the uplift for the aircraft is initially taken over by the flow around the successively approaching partial wings and finally by the forming complete wing.

When transitioning from the horizontal flight mode to the transient flight state, i.e. when the partial profiles are pivoted apart minimally so that there are no gaps (because the partial profiles overlap at their joints) or minimal, defined gaps between the partial profiles of the partial-profile pivoting wings, a desired increase in the wing surface or the total profile depth occurs, which also has a beneficial effect on the flight behaviour, in particular the gliding behaviour when taking off or landing or when soaring, and can be used specifically for flight manoeuvres.

The use of the partial-profile pivoting wing according to the invention thus combines both worlds in terms of flight technology, namely that of the aircraft on the one hand and that of the helicopter or multicopter on the other, and thus allows highly flexible, different flight states with one and the same aircraft.

In horizontal flight, the aircraft develops the properties known from a conventional aircraft, such as: a high cruising speed and conventional landing and take-off on a runway and gliding ability in emergency situations, and in take-off or landing or hovering flight state the properties known from a multicopter, namely space-saving take-off and landing or precise manoeuvrability both horizontally and vertically at the lowest speeds. Furthermore, the aircraft can switch flexibly and seamlessly between these two flight states and can therefore be adapted as desired to the respective take-off and landing conditions (runway, point-shaped landing zone) or the respective area of operation (e.g. long-distance flights at high speeds on the one hand or, on the other hand, the transport of people or materials in impassable terrain with possibility for landing or difficult landing infrastructure, such as in urban areas.

Further, particularly advantageous embodiments and further developments of the invention are obtained from the dependent claims and the following description.

The pivoting wing can comprise one pivotable partial profile or several pivotable partial profiles or consist only of pivotable partial profiles.

The pivoting wing can also comprise a combination of at least one rigid partial profile, i.e. non-pivotable partial profile, and at least one pivotable partial profile. An example of this embodiment is a pivoting wing that consists of two partial profiles (we only consider one side of the aircraft for this). The rear partial wing, if it already has a larger sweep (e.g. 30° to the rear) can be a fixed—i.e.—rigid partial wing, which therefore comprises the rigid partial profile. The pivotable partial profile would simply be extended (pivoted out) towards the front for take-off/landing/hovering and pivoted/folded “towards the back” for horizontal flight.

Regardless of the specific implementation variant, the individual partial profiles, when these partial profiles are pivoted together, combine to form a complete aerofoil profile or a complete wing profile, and the partial profiles, when these partial profiles are moved apart or pivoted out, form individual profiles of the aerofoil profile.

The control of the movement of the partial wings as well as the alignment of the effect of the drive can be carried out manually by an experienced pilot.

Preferably, however, the control is carried out with the aid of an on-board computer of the aircraft which is programmed in such a way that it provides the computer-aided procedure when executing its program, in particular fully automatically in the case of an unmanned aircraft. In this case, the on-board computer controls or monitors-depending on the control inputs from the pilot or a device that automatically remotely controls the aircraft or previous programming, taking into account a wide variety of sensor data and/or flight route data or GPS data, the movement of the partial wings as well as the direction of action of the drives.

The sensor data can represent, for example, the speed of the aircraft over ground, the altitude above ground, the attitude of the aircraft and all flight parameters, etc. and/or weather or weather data which has been collected using aircraft sensors or transmitted to the aircraft via data transmission.

When executing the program, the on-board computer generates control data or signals that are transmitted electronically or optically (e.g. via cable or signal or data bus) to actuators known to those skilled in the art. An actuator is understood to be a drive unit which converts an electrical control signal output by the on-board computer or control data output by the on-board computer into movement or a physical quantity, such as pressure. The actuators can be electro-mechanical, pneumatic or hydraulic actuators.

A first type of actuator is connected on the one hand to the fuselage of the aircraft and on the other hand to the partial wing and converts the control data or signals into a movement of the respective partial wing. The first type of actuator causes the partial wings to pivot either directly or via a transmission.

A second type of actuator is connected on the one hand to the relevant partial wing (there with the supporting parts, such as the spar or the spars) and on the other hand to the drive or to a device for influencing the direction of action of the drive of the relevant partial wing and converts the control data or signals into a desired direction of action of the drive. This conversion can involve a pivoting of the drive so that the direction of action of the drive can be adjusted from horizontal to vertical and vice versa. However, this conversion can also involve adjusting an outlet opening of the device for influencing the direction of action of the drive. The alignment of the drive itself remains unaffected, whereas the air flow/or mass flow generated with the aid of the drive is changed with respect to its exit direction from the outlet opening between horizontal and vertical or vice versa. This can be a shaft that can be deformed in a variable direction or a shaft with one horizontal outlet opening and one downwardly directed outlet opening, whereby the horizontally exiting air flow or mass flow fraction and vertically exiting air flow or mass flow fraction can be variably adjusted in the shaft by means of an adjustable flap. If the second type of actuator only changes the direction of the air or mass flow caused by the drive and the alignment of the drive is left unchanged, the actuator does not necessarily have to be connected to the partial wing, but can also be directly integrated into the drive or connected to it as a supporting element.

It should be noted at this point that the first and second types of actuator can differ in terms of the implementation used, but in principle they do not have to be designed differently. The differentiation into the first and second type of actuator is only due to the different intended uses on the aircraft.

Furthermore, it should be mentioned that the relative movement of the partial profiles towards or away from each other can be initiated or carried out by the individual drives attached to the partial profiles by changing the air flow, the mass flow or the impulse at the individual drives. The movement of the partial profiles in the desired direction is generated by means of the drives

The control of the drives can also be carried out manually by the pilot. Preferably, the on-board computer supports the pilot. Particularly preferably, the on-board computer controls the drives in the different flight states—depending on control inputs from the pilot or a device that automatically remotely controls the aircraft, or fully automatically or autonomously—in order to achieve the desired flight response. Depending on the respective flight manoeuvre, the power supply for each drive is also regulated separately in order to carry out the desired flight manoeuvres and to ensure stable flight behaviour in the various flight states. For example, in emergencies, such as an engine failure, a compensation of any asymmetry can be achieved or if necessary, an asymmetry can be created, e.g. to be able to compensate for gusts of wind.

In order to equip the entire wing with the highest possible load reserves and thus with a high level of safety, it has proven advantageous that the partial profiles are locked when the partial profiles are pivoted together. The locking can be realized, for example, by means of one or more bolts or another mechanical locking device, wherein the bolt or the locking device is coupled to an actuator which is controlled by the on-board computer in order to effect the locking or to release the locking. Particularly preferably, the locking is realized with a self-blocking locking mechanism that can be released by means of an actuator and which locks automatically as soon as the partial profiles touch each other. The unlocking is also performed either manually by the pilot or controlled by the on-board computer.

The partial-profile pivoting wing can comprise two or more partial profiles.

Since one drive is preferably used per partial profile, a number of drives corresponding to the number of partial profiles can be provided for each partial-profile pivoting wing. By increasing the number of drives, for example, in the case of rotor drives, the rotor diameter used can be reduced with the same effect, which contributes to more ground clearance during landing and take-off (in the horizontal flight state). The length of the landing gear, which defines the distance between the fuselage and the runway, can therefore be designed to be correspondingly shorter, resulting in a more stable and resilient configuration.

As already addressed, it should also be mentioned that the entirety of the partial profiles of the partial-profile pivoting wing can also comprise one or more partial profiles that are rigidly formed to the fuselage.

Particularly preferably, each partial profile comprises the external shape of a segment of the aerofoil profile. Thus, each partial profile has at least a residual aerofoil effect itself as a partial wing, which provides uplift when the airflow comes from the front, especially during the transition flight state. Furthermore, when pivoted together, the partial profiles combine seamlessly to form a complete wing profile, which complete wing profile provides the uplift required for the aircraft in the horizontal flight state.

Preferably, the structure of the partial profile is designed such that the partial profile consists of a partial wing profile segment and one spar or several spars. Each partial profile has the external shape of a segment of an aerofoil profile. The partial wing profile segment is/can be designed to be flow-optimised, whereas the spar provides the relevant partial profile or partial wing with the required stiffness or resistance or stability. The spar is incorporated into the partial wing and runs substantially along the longitudinal extension of the partial wing. The cross-section of the spar preferably has approximately the shape of an I-beam, which nestles against the inside of the partial wing profile segment for force transmission. The partial wing profile segment thus defines the external shape of the partial wing surrounding the spar—at least on one side, i.e. at the front or rear with respect to the direction of travel in the horizontal flight state. Particularly preferably, the partial wing profile segment and the spar are designed as individual components. This means that the two are integrally connected to each other, are preferably made from one material and not from different materials, in particular are manufactured together in one operation. This one-piece design improves the load-bearing capacity and makes it easier to produce a partial wing that is as light as possible and yet stable, especially when using composite materials.

The individual component can also be made from different materials connected to one another, whereby these different materials are connected to each other for example by gluing, riveting or other known types of connection.

According to a particularly preferred embodiment, one rigid partial profile or several rigid partial profiles can be provided. Viewed from the flight direction in horizontal flight mode, the at least one rigid partial profile can be located between two pivotable partial profiles or can be provided in front of the first pivotable partial profile or after the last pivotable partial profile. The rigid partial profile(s) can be provided between, behind or in front of two or more pivotable partial profiles. Quite generally, the shape of the partial profiles, regardless of whether it is a rigid partial profile or a pivotable partial profile, can be designed in such a way that the partial profiles pivoted relative to each other, i.e. the resulting overall profile, produce the aerofoil profile or a segment of the aerofoil profile. In particular, the rigid partial profile as such can be a form of an aerofoil profile and the pivotable partial profile(s) can be adapted to the shape of the rigid partial profile on their side facing the rigid partial profile, so that when the partial profiles are joined together, the complete wing profile is again obtained. In this way, the partial wing formed from the rigid partial profile can provide a good uplift during the approach flow, particularly during the transition flight state, and can significantly relieve the load on the drives during their uplift effect above a certain approach flow speed.

Preferably, the movable or pivotable partial profiles can be narrower than the rigid partial profile. Narrower means here that the movable or pivotable partial profiles have a smaller profile depth compared to the rigid partial profile. The advantage of this embodiment is a larger wing depth with narrower moving partial profiles.

It should be noted that the profile thickness across the profile (viewed in the cross-section of the overall profile) of the pivoting wing preferably runs continuously in the pivoted-together state. This reduces turbulence and separations and thus allows a performance and therefore fuel-optimized flight when using the partial-profile pivoting wing.

The maximum profile thickness of the movable or pivotable partial profiles is preferably smaller than the maximum profile thickness of the rigid partial profile. The maximum profile thickness here is the largest profile thickness of the respective profile section without additional structures such as antenna configurations or similar. The rigid partial profile therefore preferably, but not necessarily, has the largest profile thickness of the entire profile of the pivoting wing.

According to a further aspect, it is provided that the pivotable partial profile comprises at least one of the drives specified hereinafter, namely engine-propeller combination; jet engine; impeller or another type of drive acting through mass flow.

Several drives can be provided which are used for the different flight states or flight modes (primary). For example, a drive can be provided that provides a thrust to the rear and can therefore be used mainly for the horizontal flight mode is, whilst another drive provides a thrust directed substantially downwards, i.e. in the vertical direction, and thus the essential thrust (i.e. the force or lifting force) for the take-off or landing or hovering flight state. The two different thrust directions can be provided independently of each other and/or obtained in a synchronized manner with each other to implement continuous transitions between the flight states.

Particularly preferably-as already addressed-a propulsion caused by the drive can be converted into a downwardly directed force or lifting force, in particular by means of a pivotable drive.

Preferably, the drive can be pivoted relative to a fuselage-surface transition or an aerofoil root of the pivoting wing, so that the direction of the thrust can be changed analogously to the pivoting of the drive, in particular so that the thrust can be pivoted towards the vertical direction. Preferably therefore, the direction of thrust can be pivoted about the transverse axis of an aircraft equipped with the pivoting wing. For this purpose, the profile of the pivoting wing or a partial profile can be designed to be pivotable, in particular pivotable against the aerofoil root. The drive itself can also be designed to be pivotable against the profile of the pivoting wing and/or a partial profile.

Particularly preferably, when the configuration of the engine-propeller combination is present as the drive, the forward-oriented partial profile of the aerofoil profile comprises either a pull propeller or a push propeller and the rearward-oriented partial profile of the aerofoil profile comprises either a pull propeller or a push propeller. This combination contributes to increased power delivery and improves the airflow required for the uplift in the horizontal flight state. Insofar as the forward-oriented partial profile of the aerofoil profile comprises the push propeller, it is advantageous that the front partial profile is configured to be longer than the rear partial profile.

In flight, the partial profiles or the partial wings support the fuselage of the aircraft, whereby the power transmission can be realized according to two embodiments, namely as follows:

According to a first embodiment, the aircraft can comprise a spar box, wherein the partial profiles are realized as individual spars and each connected to the spar box and thus to the fuselage by individual spar bolts. The individual spars only have to take on the respective loading of the individual partial wing and can be maintained individually. In this configuration, the individual wings can also be replaced easily, i.e., independently of one another.

According to a further embodiment, the partial profiles can consist of spars extending from one side of the fuselage to the other side of the fuselage, wherein the continuous spars are connected to the fuselage by means of a central mount. These continuous spars cross each other in the central mount and thus extend to the left and right sides of the fuselage. This has the advantage that the partial wing running from the left side of the fuselage to the right side of the fuselage can be formed in one piece. This improves the stability and resilience as well as the force transmission to the fuselage. In this context, it should be noted that the phrase “partial profiles as individual spars” is to be understood as meaning that this is a partial wing extending on both sides of the fuselage.

Existing manufacturing techniques and known materials can be used to manufacture the partial wings and the spars. Finally, it should be mentioned in general that the electronic devices discussed (on-board computers or sensors, etc.) comprise electronics. The electronics can be constructed as discrete or by integrated electronics or a combination of both. Microcomputers, microcontrollers, application specific integrated circuits (ASICs) can also be used, possibly in combination with analogue or digital electronic peripheral components. Many of the mentioned functionalities of the devices are realized possibly in cooperation with hardware components-with the aid of software that is executed on a processor of the electronics. Devices designed for radio communication usually comprise an antenna configuration for transmitting and receiving radio signals as part of a transceiver module. The electronic devices may also have an internal electrical power supply, which may be implemented, for example, with a replaceable or rechargeable battery. The devices can also be supplied in a grid system either via an external power supply or via a signal or data bus.

These and other aspects of the invention will become apparent from the figures discussed hereinafter.

### BRIEF DESCRIPTION OF THE FIGURES

The invention is explained in more detail hereinafter with reference to the accompanying figures using exemplary embodiments, to which the invention is, however, not restricted. In the various figures, the same components are provided with the same reference numbers. In the figures shown schematically:

FIG. 1 shows partial wings of two partial-profile pivoting wings of an aircraft, moved apart or pivoted out;

FIG. 2 shows the partial wings pivoted together to form a complete wing profile according to FIG. 1;

FIG. 3a shows a complete wing composed of two partial wing profiles;

FIG. 3b shows the two partial profiles assembled with a form fit;

FIG. 3c shows a complete wing composed of three partial wing profiles;

FIG. 3d shows the complete wing with a partial profile comprising a wing profile;

FIG. 4 shows an individual connection to the fuselage of the aircraft for each of the two partial profiles of the complete wing;

FIG. 5 shows a common central connection connecting the fuselage of the aircraft with two partial profiles spanning the fuselage;

FIG. 6 shows the individual connection according to FIG. 4 in the case of three partial profiles;

FIG. 7 shows the central connection according to FIG. 5 in the case of three partial profiles;

FIG. 8 shows the aircraft with a pivotable push propeller engine nacelle on each of the partial wings of the complete wing in horizontal flight;

FIG. 9 shows a pivoting of the engine nacelle of the front half or partial wing of the aircraft according to FIG. 8;

FIG. 10 shows a pivoting of the engine nacelle of the rear half or partial wing of the aircraft according to FIG. 8;

FIG. 11 shows the aircraft with a pivotable pull propeller engine nacelle on the front half or partial wing of the complete wing and a pivotable push propeller engine nacelle on the rear half or partial wing of the complete wing in horizontal flight;

FIG. 12 shows a pivoting of the engine nacelle of the respective half or partial wing of the aircraft according to FIG. 11;

FIG. 13 shows the aircraft in the take-off or landing or hovering flight pattern;

FIG. 14 shows the aircraft with a rigid, central partial profile of the respective complete wing in the take-off or landing or hovering flight pattern;

FIG. 15 shows a first embodiment of the three partial profiles of the complete wing according to FIG. 14;

FIG. 16 shows a second embodiment of the three partial profiles of the complete wing according to FIG. 14,

FIG. 17 shows the aircraft according to FIG. 14 with a further embodiment of the partial-profile pivoting wing;

FIGS. 18 and 19 show different embodiments of the aircraft concerning the pivoting of the partial profiles.

### DESCRIPTION OF THE EXEMPLARY EMBODIMENTS

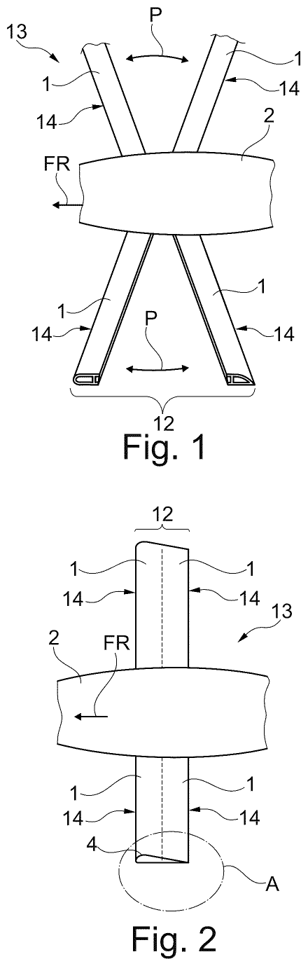

FIG. 1 shows a section of a fuselage 2 of an aircraft 13. A pair of partial wings 14 with a partial profile 1 extends to the right and left sides of the fuselage 2 (relative to the flight direction FR or the longitudinal extension of the fuselage). The partial wings 14 are shown moved apart or pivoted out as indicated by the arrows P. They are have the shortest distance from one other at fuselage 2. The further they extend from fuselage 2, the more the distance between them increases. The aircraft 13 adopts this configuration of the partial wings 14, for example, during vertical take-off or landing or when hovering. The pairs of partial wings 14 extending to the left and right sides of the fuselage 2 each comprise the partial profile 1, wherein the partial wing profiles of the pairs of partial wings 14 complement each other to form a complete wing with a complete wing profile or an aerofoil profile 4 when the pairs of partial wings 14 are pivoted together, as shown in FIG. 2. The aircraft 13 according to FIG. 2 comprises this configuration of the partial wings 14 during horizontal flight or during landing or take-off from a runway.

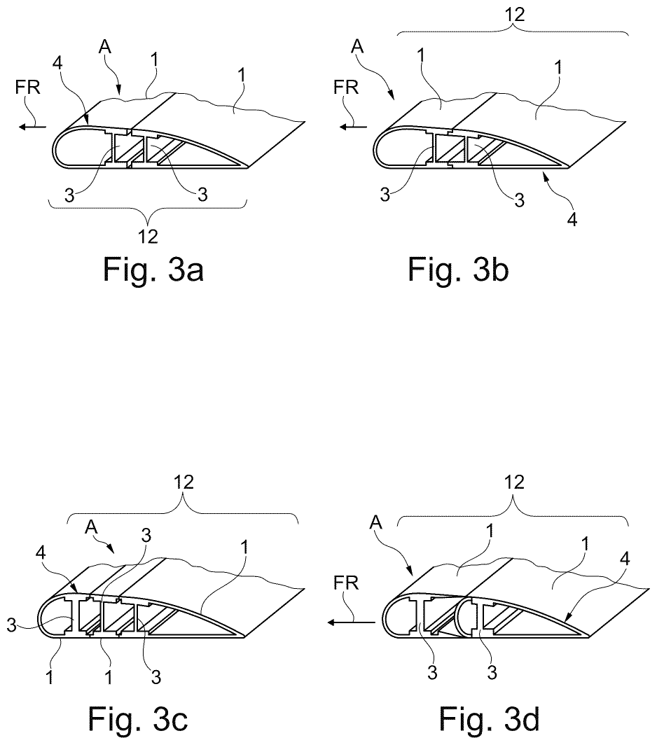

FIGS. 3a to 3d show various embodiments of the aerofoil profile 4 based on a segment A of the complete wing circled in FIG. 2, wherein the complete wing is shown cut perpendicular to its longitudinal extension in order to make the partial profiles 1 as well as the complete aerofoil profile 4 visible. Quite generally, a partial wing 14 comprises a spar with an outer skin and can be formed to be open or closed towards the front. The same applies to the rear shape of the partial wing 14.

FIG. 3a shows an aerofoil profile 4 composed of two partial profiles 1. Here, the front partial profile 1, oriented in the direction of flight FR, shows on its front side the typical rounding of an aircraft wing, which runs rather flat towards the rear on the underside of the wing, whereas the partial profile 1 on its upper side runs curved rather upwards and then slightly sloping towards the rear. The rear partial profile 1, oriented away from the direction of flight, shows the contour that tapers towards the rear, which is typical for an aircraft wing. Each of the partial profiles 1 comprises a spar 3 which has the shape of an I-beam and extends along the longitudinal extent of the complete wing. In the front partial profile 1, the spar 3 terminates the partial profile 1 towards the rear, whereas in the rear partial profile 1, the spar 3 terminates the rear partial profile 1 towards the front. The spar 3 is the load-bearing component of an aircraft wing, here specifically the partial wing 14. The spars 3 can come to lie positioned at a slight distance from one another in the aerofoil profile 4 composed of the two partial profiles 1 or they can touch one another. Preferably, however, the spars 3 overlap in a strip-like manner, as shown in FIG. 3b, so that a tight fit is achieved which gives the aerofoil profile 4 a high degree of stability. The aerofoil profile 4 shown in FIG. 3c comprises three partial profiles 1, the outer contours of which substantially merge seamlessly into one another, so that when the partial profiles 1 are pivoted together, the aerofoil profile 4 is formed again. The middle partial profile 1 here forms a bridge to lengthen the aerofoil profile depth between the front partial profile 1 and the rear partial profile 1 and/or to stiffen the complete wing. The middle partial profile 1 also comprises the spar 3. The partial profile 1 of the middle partial wing 14 is aerodynamically unfavourable, which can, however, be advantageous during braking/deceleration. The same applies to the partial profiles 1 of the rear partial wings 14 of the embodiments according to FIGS. 3a and 3b. FIG. 3d shows a rear partial profile 1 which for itself comprises the typical contour for a wing. The front partial profile 1 is shaped on its side facing the rear partial profile 1 in such a way that the forward-directed rounding of the rear partial profile 1 is accommodated in an area adjacent to or adjoining the spar 3, whereby an asymmetrical overlap is also possible.

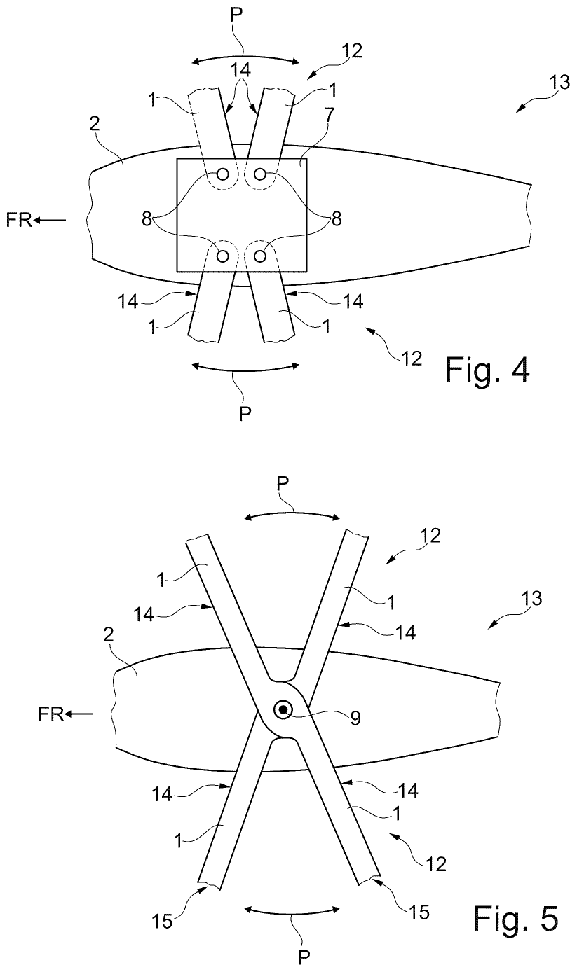

FIG. 4 shows how the partial wings 14 with their respective partial profile 1 are attached to the fuselage 2 by means of a spar box 7. This involves the attachment of four separate partial wings 14, with two of the partial wings 14 extending in pairs from the spar box 7 to the respective side (right side or left side with respect to the flight direction FR) of the fuselage 2. For this purpose, a single spar bolt 8 is provided for each partial wing 14, which provides the pivotable fastening of the partial wing 14 to the spar box 7. Each partial wing 14 can thus be pivoted about the respective spar axis of the respective individual spar 8, i.e. substantially about a vertical axis when the fuselage 2 is aligned substantially horizontally along its longitudinal extension. In this configuration, all four partial wings 14 can be pivoted individually, which is brought about, for example, by means of four individual actuators, or the partial wings 14 extending in pairs to the respective side of the fuselage are pivoted synchronously with each other, which is brought about with two actuators or even with only a single actuator and a transmission.

FIG. 5 shows a further configuration of the partial wings 14 with their respective partial profile 1, wherein here a partial wing 14 extending to the left side of the fuselage 2 and a partial wing 14 extending to the right side of the fuselage 2 are designed in one piece, so that a combination partial wing 15 is present. The two partial wings 14 of the combination partial wing 15 run substantially in a line or slightly offset from each other. This one-piece configuration enables the use of a single central mount 9 for fastening the two combination partial wings 15, whereby the combination partial wings 15 can be pivoted around the central mount 9. Also in this configuration, the combination partial wings 15 can be pivoted separately by individual actuators or together by a common actuator.

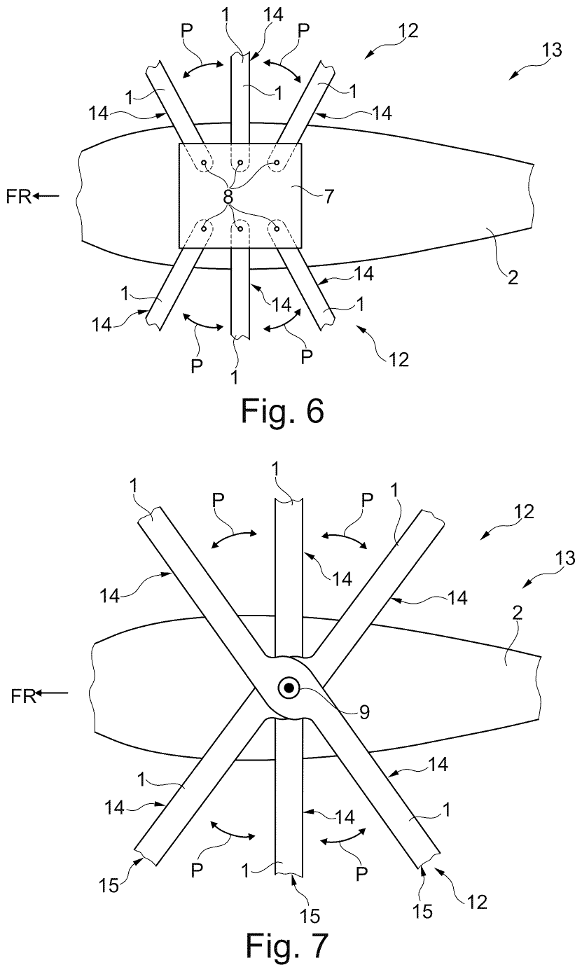

As shown in FIG. 6, more than two separate partial wings 14 can be provided. In the present case, there are three per side of the fuselage. Each partial wing 14 is attached by means of a separate single spar bolt 8. The number can also be increased in the case of partial wings 14 that extend from one side of the fuselage to the other side of the fuselage, i.e. the combination wings, which is visualized in the case of FIG. 7 with three combination wings, which in turn are connected to the fuselage 2 by means of the central mount 9.

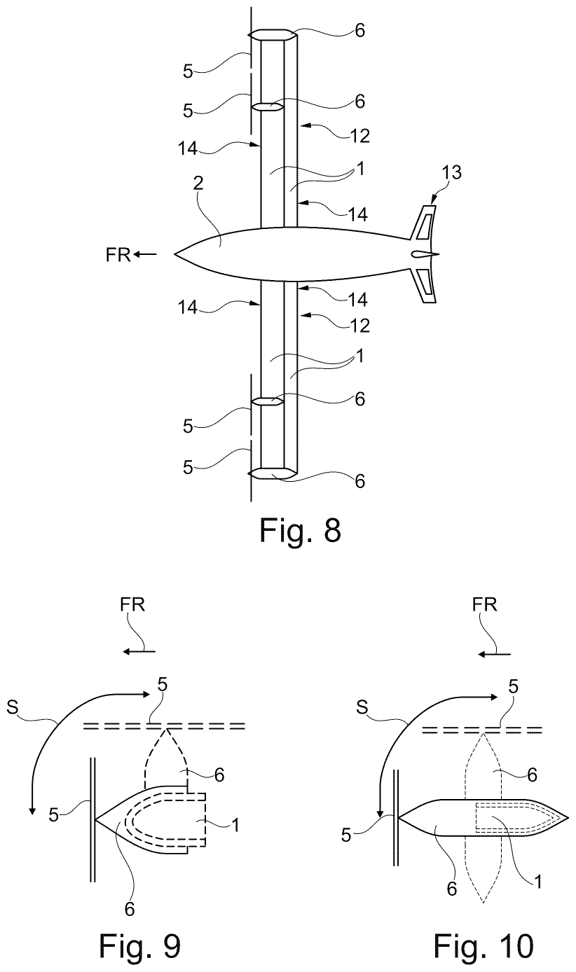

FIG. 8 is discussed hereinafter, which shows the aircraft 13 from above in a horizontal flight. In this aircraft 13, each partial wing 14 is equipped with an engine nacelle 6 with a pull propeller 5, wherein the two outer engine nacelles 6 are attached to the rear partial wings 14 and the inner engine nacelles 6 are attached to the front partial wings 14. Each of the engine nacelles 6 is attached to the partial wings 14 in such a way that it can be pivoted upwards together with the propeller 5 according to the indicated pivot range S (see FIG. 9) in order to create a lifting force with the aid of the propeller 5. The engine nacelle pivoting is visualized in FIG. 9 for the engine nacelle 6 attached to the front wing 14, which is drawn in its two extreme positions on the one hand with solid lines and on the other hand with broken lines. Also, the partial profile 1 of the front partial wing 14 is visualized with broken lines. The engine nacelle pivoting is visualized in FIG. 10 for the engine nacelle 6 attached to the rear partial wing 14, which is drawn in its two extreme positions on the one hand with solid lines and on the other hand with broken lines. Also, the partial profile 1 of the rear partial wing 14 is visualized with broken lines.

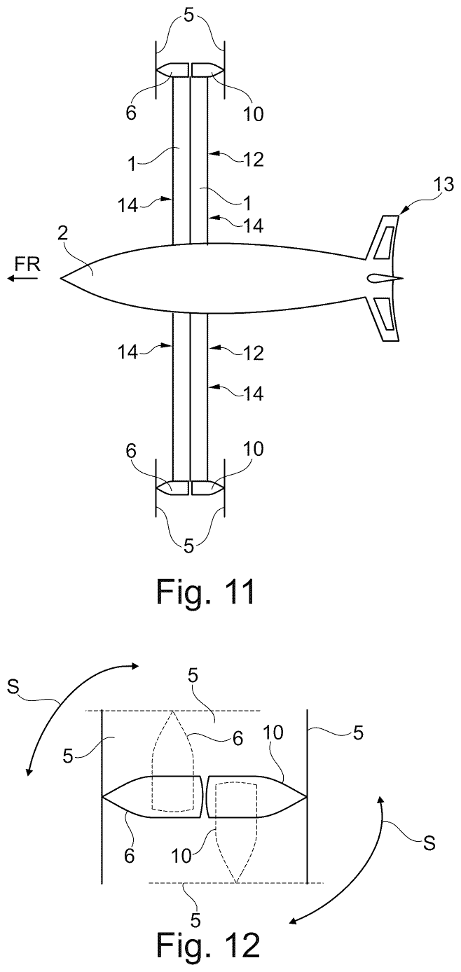

FIG. 11 is discussed hereinafter, which shows the aircraft 13 from above in a horizontal flight. The aircraft 13 has an engine nacelle 6 or 10 at each end of the partial wings 14, wherein pull propellers 5 are mounted on the front partial wings 14 and push propellers 5 are mounted on the rear partial wings 14. Each of the engine nacelles 6 provided on the front partial wings 14 is attached to the partial wings 14 in such a way that it can be pivoted upwards together with the pull propeller 5 according to the indicated pivot range S (see FIG. 12) in order to create a lifting force with the aid of the propeller 5. Each of the engine nacelles 10 provided on the rear partial wings 14 is attached to the partial wings 14 in such a way that it can be pivoted downwards together with the propeller 5 according to the indicated pivot range S (see FIG. 12) in order to create a lifting force. The pivoting of the engine nacelles 6 is subsequently visualized in FIG. 12, whereby on both sides of the fuselage 2 the respective engine nacelle 6 with the pull propeller 5 is pivoted upwards and the engine nacelle 10 with the push propeller 5 is pivoted downwards. The representation of the partial profiles 1 was omitted here.

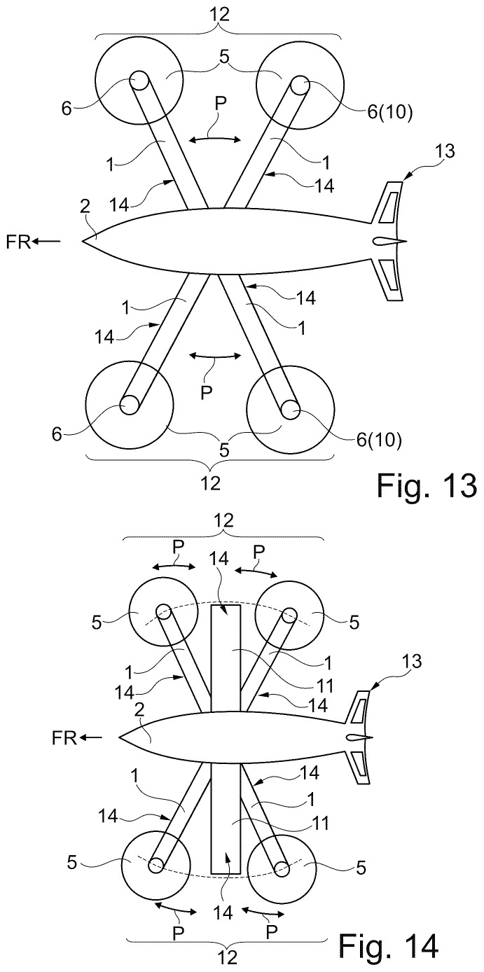

FIG. 13 shows the aircraft 13 during take-off, landing or hovering, with the partial wings 14 fanned out, i.e. the partial profiles 1 are pivoted apart from one another or pivoted out. The effect of the propeller 5 is directed downwards, so that the required lifting force is achieved.

FIG. 14 shows the aircraft 13 according to a further embodiment of the partial-profile pivoting wing 12. In this embodiment, a central (middle) and rigid partial wing 14 is provided, which is flanked at the front and rear by respectively one pivotable partial wing 14. Again, each pivotable partial wing 14 comprises the engine nacelle 6. The rigid partial wing 14 is shown here without an engine nacelle. Also in the present case, FIG. 14 shows the aircraft 13 from above during take-off, landing or hovering. Here too, the effect of the propeller 5 is directed downwards, so that the required lifting force is achieved.

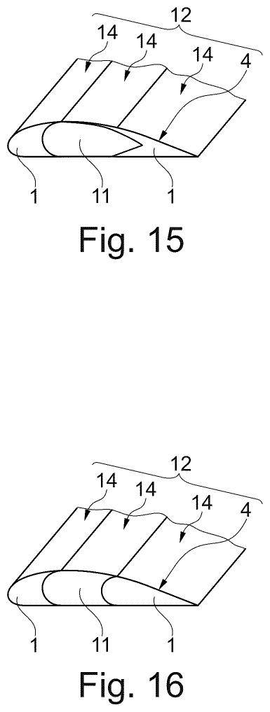

FIG. 15 shows a first embodiment of the partial wings 14 used in the aircraft 13 according to FIG. 14. Here, the rigid partial profile 11 of the central (middle) partial wing 14 substantially comprises the typical contour of an wing, whereas the two adjacent pivotable partial profiles 1 are shaped in such a way that they accommodate the rigid partial wing 14 on the respective side, so that the combination of the three partial profiles 1 and 11 and 1 again results in the complete wing profile or the aerofoil profile 4. Although present, the individual representation of the spars was omitted here.

FIG. 16 shows a second embodiment of the partial wings 14 used in the aircraft 13 according to FIG. 14. Here, the rear pivotable partial profile 1 substantially comprises the typical contour of a wing, whereas the two partial profiles 1 and 11 located in front of it are shaped analogously to a wing only on their front side as well as their upper and lower sides. Their rear sides are shaped in such a way that the respective partial wing profile 11 or 1 located contrary to the flight direction FR is seamlessly accommodated, so that in the combination of the three partial profiles 1 and 11 and 1 the complete wing profile or the aerofoil profile 4 is again obtained. Although present, the individual representation of the spars was omitted here too.

In contrast to FIG. 14, FIG. 17 shows that the pivotable partial profiles 1, i.e. the front partial wing 14 and the rear partial wing 14, are pivotably attached to the non-pivotable, middle partial wing 14 at a distance from the fuselage 2.

In the present case, this fastening is provided approximately centrally along the fixed, middle partial wing 14. The partial profiles 1 of the three partial wings 14 can have similar dimensions or proportions or—as indicated in FIG. 17—can also differ greatly from one another.

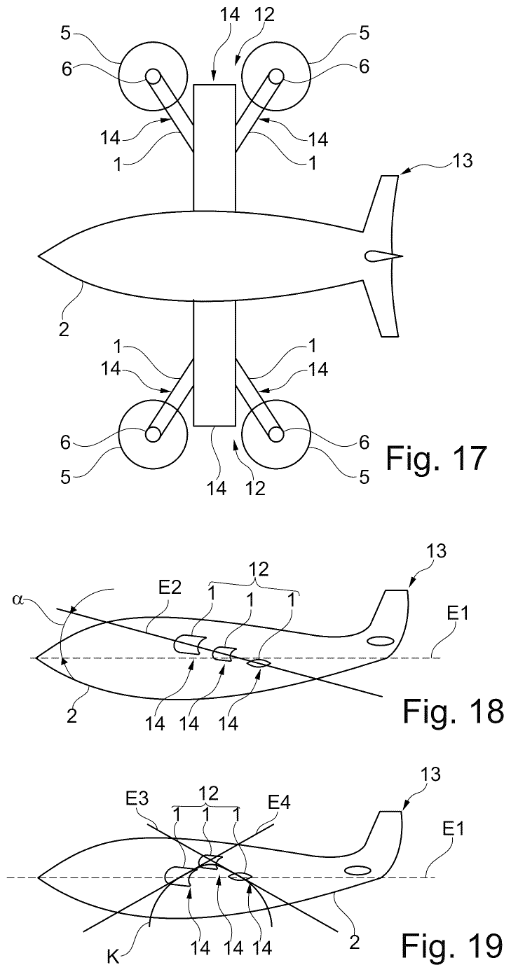

In the following, FIGS. 18 and 19 are discussed, in which different variants relating to the pivoting of the partial wings 14 are visualized. The three partial profiles 1 shown are again shaped in such a way that when joined together they form the complete aerofoil profile 4 or the complete wing profile. This is visualized in FIGS. 18 and 19 using the size ratios of the three partial profiles 1.

Specifically, FIG. 18 shows a first plane EI which runs normally to the plane of the drawing and along the aircraft axis. The partial profiles 1 are shown pivoted along a second plane E2, wherein, viewed at the nose of the aircraft 13, the second plane E2 is inclined upwards by an angle alpha (α) relative to the first plane E1. The pivoting along the second plane E2 causes the front partial wing 14 to be raised with respect to the middle partial wing 14 and the rear partial wing 14 to be lowered with respect to the middle partial wing 14. At least the front and rear partial wings 14 are pivoted here, whereby the middle partial wing 14 can also be pivoted, but does not have to be. It should also be mentioned that, when viewed at the nose of the aircraft 13, the pivoting of the plane E2 relative to the plane E1 can also take place downwards. Furthermore, FIG. 19 shows that the front partial wing 14 and the rear partial wing 14 can be pivoted in relation to the middle partial wing 14 along different planes E3 and E4. Each of these planes E3 and E4 can be individually inclined with respect to the first plane E1. In the present case, the front partial wing 14 is lowered along the fourth plane E4 with respect to the middle partial wing 14 and the rear partial wing 14 is lowered with respect to the middle partial wing 14 along a third plane E3. It should be mentioned here that this pivoting of the partial wings 14 can also take place along a curve K.

In all the embodiments discussed, in which a pivoting takes place along a plane, such as, for example, the plane E2, E3 or E4, the pivoting mechanism is configured to initiate a movement in the respective plane E2, E3 or E4 or simply oriented accordingly or installed inclined with respect to the first plane E1, for example, or the aircraft axis. If the pivoting takes place along a curve, the pivoting mechanism must enable the curve shape. For this purpose, a guide curved according to the shape of the curve can be provided for guiding the partial wings 14, so that e.g. a rotary movement of the respective actuator is converted into a pivoting of the partial wing 14 according to the curve shape.

Finally, it is pointed out once again that the figures described in detail above are only exemplary embodiments which can be modified in various ways by a person skilled in the art without departing from the scope of the invention. For the sake of completeness, it should also be noted that the use of the indefinite articles “ein” or “eine” does not exclude the possibility that the relevant features may also be present more than once.

1. Pivoting wing (12) for an aircraft (13), characterized in that the pivoting wing is designed as a partial-profile pivoting wing, wherein the partial-profile pivoting wing is assembled from individual partial profiles (1) when these partial profiles (1) are pivoted together.

2. Pivoting wing (12) according to claim 1,
wherein the individual partial profiles (1), when the partial profiles (1) are pivoted together, are assembled to form a complete wing profile (4) or a complete wing profile, and
wherein the partial profiles (1), when the partial profiles (1) are moved apart or pivoted out, form individual profiles of the wing profile (4).

3. Pivoting wing (12) according to claim 1, wherein the partial profiles (1) are locked when the partial profiles (1) are pivoted together.

4. Pivoting wing (12) according to claim 1, which comprises two or more partial profiles (1).

5. Pivoting wing (12) according to claim 1, wherein each partial profile (1) comprises the external shape of a segment of the aerofoil profile (4).

6. Pivoting wing (12) according to claim 1 , wherein the partial profile (1) consists of a partial wing profile segment and a spar (3) or a plurality of spars (3).

7. Pivoting wing (12) according to claim 6, wherein the partial wing profile segment and the spar (3) are formed as a single component.

8. Pivoting wing (12) according to claim 1, which comprises one rigid partial profile (11) or several rigid partial profiles (11).

9. Pivoting wing (12) according to claim 8, wherein the movable or pivotable partial profiles (1) are narrower in comparison to the rigid partial profile (11).

10. Pivoting wing (5 12) according to claim 1, wherein the pivotable partial profile (1) comprises at least one of the drives (6, 10) specified hereinafter, namely:
motor-propeller combination;
jet engine;
impeller;
another type of drive acting through mass flow.

11. Pivoting wing (12) according to claim 10, wherein a propulsion caused by the drive (6, 10) can be converted into a lifting force, in particular by a pivotable drive (6, 10).

12. Pivoting wing (12) according to claim 10, wherein when the configuration of the motor-propeller combination is present as the drive (6, 10), the forward-oriented partial profile (1) of the wing profile (4) comprises a pull propeller or a push propeller and the rearward-oriented partial profile (1) of the wing profile (4) comprises either a pull propeller or a push propeller.

13. Aircraft (13) comprising a fuselage configuration which, depending on the design, comprises a fuselage (2) or a double fuselage or a multiple fuselage construction, and a pivoting wing (12) according to claim 1 on the left and right sides of the fuselage configuration.

14. Aircraft (13) according to claim 13, which comprises a spar box (7), wherein the partial profiles (1) are realized as individual spars and are each connected to the spar box (7) and thereby to the fuselage (2) by individual spare bolts (8).

15. Aircraft (13) according to claim 13, wherein the partial profiles (1) consist of spars extending from one side of the fuselage (2) to the other side of the fuselage (2), wherein the continuous spars are connected to the fuselage (2) by means of a central receptacle (9).

16. Computer-aided method for operating an aircraft (13) with a pivoting wing (12) according to claim 1 one in the flight states specified hereinafter, namely:
in a horizontal flight state in which the partial profiles (1) of the respective partial-profile pivoting wing are pivoted together and a complete wing thus formed with the effect of a drive (6, 10), in particular of the respective partial profile (1), generates the aircraft uplift, like a conventional aircraft, and
in a transition flight state in which the partial profiles (1) are moved apart so that partial wings (14) are formed from the complete wing, whereby the aircraft uplift of the complete wing decreases, possibly being partially taken over by the individual partial wings, whilst the drive or an effective direction of the drive is successively pivoted in such a way that the decrease in the uplift of the complete wing is compensated when the partial profiles move apart, and
in a take-off or landing or hovering flight state in which the partial profiles (1) of the partial-profile pivoting wing are moved apart and purely the directed effect of the drive (6, 10) provides the necessary power for the take-off or landing or hovering flight state.
